(19) United States
(12) Patent Application Publication
(10) Pub. No.: US 2006/0034537 A1
(43) Pub. Date: Feb. 16, 2006

(54) Human body detecting device and human body detecting method

(75) Inventor: Yasuo Masaki, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-Shi (JP)

(21) Appl. No.: 11/196,796

(22) Filed: Aug. 3, 2005

(30) Foreign Application Priority Data
Aug. 3, 2004 (JP) P. 2004-227271

(51) Int. Cl. G06K 9/40

(52) U.S. Cl. 382/254

(57) ABSTRACT

A human body detecting device for detecting whether a person is included in a photographed image, including: near infrared ray light sources having different wavelengths; an imaging lens which converges light to form a subject image; an imaging element which forms a subject picture; a storing unit which stores the subject picture and spectrum reflectance information obtained by associating the wavelengths of the near infrared rays with the spectrum reflectance of the person's skin; a property extracting unit which extracts a difference between pixel values of predetermined pixels of subject pictures photographed for each wavelength of the near infrared rays; and a determining unit which determines whether the pixel corresponds to the skin by comparing the difference between the pixel values with the spectrum reflectance information, and decides a region where the pixels corresponding to the skin occupy a predetermined area to a skin region.

### BACKGROUND OF THE INVENTION

1. Field of the Invention

The present invention relates to a human body detecting device and a human body detecting method.

2. Description of the Related Art

Conventionally, in a place where high security is required, a monitoring camera is provided and existence of a person or an action of the person is always monitored from a remote location. However, when a person is disguised, the person cannot be distinguished and thus cannot sufficiently be monitored by the monitoring camera. Accordingly, even when the person is disguised, a method that can detect the disguise has been disclosed. Concretely, by irradiating near infrared rays onto a head of a person and detecting near infrared rays reflected from at least one portion of the head of the person in at least a portion of an upper band of a near infrared ray spectrum, an artificial material for disguise which puts on the head is detected and thus the disguise can be detected (for example, see JP-T-2003-536303 (the term “JP-T” as used herein means a published Japanese translation of a PCT application)).

The near infrared rays are to distinguish the person. In addition, by irradiating the near infrared rays onto the skin, such as an arm of a person, capturing the light reflected from the skin, and analyzing a spectrum of the captured light using a near infrared ray spectrum method, the person is distinguished and is authenticated (for example, see JP-T-2003-511176).

Furthermore, there is a method of irradiating near infrared rays onto a measurement target region, such as the skin of a person, capturing the near infrared rays reflected from the skin, and measuring the living body action representing a living body function of the person by the near infrared ray spectrum method (for example, see JP-A-2003-339677).

However, since the devices using the near infrared rays disclosed in Patent Documents are to photograph a picture in a dark place and the photographed picture is a black and white picture having a single wavelength, a person cannot be detected from the photographed picture.

### SUMMARY OF THE INVENTION

The present invention has been made to solve the above-mentioned problems, and it is an object of the present invention to provide a human body detecting device and a human body detecting method capable of detecting the person using a picture photographed using near infrared rays.

In order to achieve the above-mentioned object, according to a first aspect of the invention, there is provided a human body detecting device for detecting whether a person is included in a photographed image, including: a plurality of near infrared ray light sources having different wavelengths; an imaging lens which converges light which is emitted from the near infrared ray light sources and reflected from a subject to form a subject image; an imaging element which has light receiving sensitivity in the near infrared ray region and forms a subject picture based on the subject image formed by the imaging lens; an infrared ray transmitting filter which cuts visible light rays; a storing unit which stores the subject picture formed by the imaging element and spectrum reflectance information obtained by associating the wavelengths of the near infrared rays with the spectrum reflectance of the person's skin; a property extracting unit which extracts a difference between pixel values of predetermined pixels of the subject pictures photographed for each of the wavelengths of the near infrared rays; and a determining unit which determines whether the pixel corresponds to the skin by comparing the difference between the pixel values extracted by the property extracting unit with the spectrum reflectance information, and decides a region where the pixels corresponding to the skin intensively occupy a predetermined area to a skin region.

According to the first aspect of the invention, when each of the near infrared ray light sources irradiates the light onto the subject, the light reflected from the subject is converged by the imaging lens to form the subject image. The imaging element having the light receiving sensitivity in the near infrared ray light sources forms the subject picture based on the subject image formed by the imaging lens and stores the subject picture in the storing unit.

Here, when it is detected whether the skin is included in the subject picture, the property extracting unit extracts the difference between the pixel values of the predetermined pixels of the subject pictures photographed for each of the wavelengths of the near infrared rays. Also, the determining unit compares the difference between the pixel values extracted by the property extracting unit with the spectrum reflectance information, determines whether the pixel corresponds to the skin, and decides a region where the pixels corresponding to the skin intensively occupy a predetermined area to a skin region. Also, when it is detected whether the skin is included in the subject picture, the infrared ray transmitting filter cuts the visible light rays and thus the imaging element receives only the near infrared rays.

Thus, since it is determined whether the skin is photographed by the difference between pixel values of the predetermined pixels of the subject pictures, it can be easily determined whether the skin is included in the subject picture. Also, since the light component having the wavelength which is not required for the detection can be cut by the infrared ray transmitting filter, the precision for detecting whether the skin is included in the subject picture can increase.

Furthermore, since the near infrared rays are used, the skin can be detected even in a dark place and thus conventional imaging defects due to the near infrared rays can be compensated.

According to a second aspect of the invention, there is provided a human body detecting device for detecting whether a person is included in a photographed image, including: a plurality of near infrared ray light sources having different wavelengths; an imaging lens which converges light which is emitted from the near infrared ray light sources and reflected from a subject to form a subject image; an imaging element which has light receiving sensitivity in the near infrared ray region and forms a subject picture based on the subject image formed by the imaging lens; a storing unit which stores the subject picture formed by the imaging element and spectrum reflectance information obtained by associating the wavelengths of the near infrared rays with the spectrum reflectance of the person's skin; a property extracting unit which extracts a difference between pixel values of predetermined pixels of the subject pictures photographed for each of the wavelengths of the near infrared rays; and a determining unit which determines whether the pixel corresponds to the skin by comparing the difference between the pixel values extracted by the property extracting unit with the spectrum reflectance information, and decides a region where the pixels corresponding to the skin intensively occupy a predetermined area to a skin region.

According to the second aspect of the invention, when each of the near infrared ray light sources irradiates the light onto the subject, the light reflected from the subject is converged by the imaging lens to form the subject image. The imaging element having the light receiving sensitivity in the near infrared ray light sources forms the subject picture based on the subject image formed by the imaging lens and stores the subject picture in the storing unit.

Here, when it is detected whether the skin is included in the subject picture, the property extracting unit extracts the difference between the pixel values of the predetermined pixels of the subject pictures photographed for each of the wavelengths of the near infrared rays. Also, the determining unit compares the difference between the pixel values extracted by the property extracting unit with the spectrum reflectance information, determines whether the pixel corresponds to the skin, and decides a region where the pixels corresponding to the skin intensively occupy a predetermined area to a skin region.

Thus, since it is determined whether the skin is photographed by the difference between the pixel values of the predetermined pixels of the subject pictures, it can be easily determined whether the skin is included in the subject picture. Furthermore, since the near infrared rays are used, the skin can be detected even in a dark place and thus conventional imaging defects due to the near infrared rays can be compensated.

A third aspect of the invention, in the human body detecting device of the second aspect of the invention, further includes a visible light component removing unit which removes influence due to a visible light component of picture data of the subject picture by subtracting picture data of a second subject picture photographed without emitting the light to the subject by the near infrared ray light source from picture data of a first subject picture photographed by emitting the light to the subject by the near infrared ray light source.

According to the third aspect of the invention, the visible light component removing unit subtracts picture data of a second subject picture photographed without emitting the light to the subject by the near infrared ray light source from picture data of a first subject picture photographed by emitting the light to the subject by the near infrared ray light source, and thus the picture data of the subject picture is influenced only by the irradiation of the near infrared ray light source.

Thus, although the filter for removing the visible light component is not provided when photographing the subject, the subject picture from which the visible light component is removed can be obtained and thus the number of the components and the cost can be reduced.

A fourth aspect of the invention, in the human body detecting device of the second aspect of the invention, further includes an infrared ray transmitting filter which cuts visible light rays.

According to the fourth aspect of the invention, since the light component having a wavelength, which is not required for detecting the person from the subject picture, can be cut, the precision for detecting the person from the subject picture can increase.

A fifth aspect of the invention, in the human body detecting device of any one of the second to fourth aspects of the invention, further includes a coordinate calculating unit for calculating coordinates of the skin region determined by the determining unit.

According to the fifth aspect of the invention, by including the coordinate calculating unit, the coordinates of the skin region determined by the determining unit can be calculated.

Thus, since the location of the skin region can be detected, the place where a person exists can be determined.

A sixth aspect of the invention provides a human body detecting method using the human body detecting device according to any one of the first to fifth aspects of the invention, including: an irradiating step of irradiating the light from each of the near infrared ray light sources onto the subject; a photographed picture forming step of converging the light which is reflected from the subject by the irradiating step to form the subject image and forming the subject picture based on the subject image; a storing step of storing the subject picture formed by the photographed picture forming step; a property extracting step of extracting the difference between pixel values of the predetermined pixels of the subject pictures photographed for each wavelength of the near infrared rays; and a determining step of comparing the difference between the pixel values extracted by the property extracting step with the spectrum reflectance information, determining whether the pixel corresponds to the skin, collecting the pixel corresponding to the skin, and deciding the region having a predetermined area to a skin region.

According to the sixth aspect of the invention, each of the near infrared ray light sources irradiates the light onto the subject by the irradiating step. By the photographed picture forming step, the light reflected from the subject is converged by the imaging lens to form the subject image, and the imaging element forms the subject picture based on the subject image formed by the imaging lens. The subject picture formed by the photographed picture forming step is stored in the storing unit by the storing step.

Here, when it is detected whether the skin is included in the subject picture, the difference between pixel values of the predetermined pixels of the subject pictures photographed for each wavelength of the near infrared rays is extracted by the property extracting step. Also, the difference between the pixel values extracted by the property extracting unit is compared with the spectrum reflectance information, it is determined whether the pixel corresponds to the skin, the pixel corresponding to the skin is collected, and a region having a predetermined area is decided to a skin region, by the determining step.

Thus, since it is determined whether the skin is photographed by the difference between pixel values of the predetermined pixels of the subject pictures, it can be easily determined whether the skin is included in the subject picture. Furthermore, since the near infrared rays are used, the skin can be detected even in a dark place and thus conventional imaging defects due to the near infrared rays can be compensated.

According to the first aspect of the invention, since it is determined whether the skin is photographed by the difference between pixel values of the predetermined pixels of the subject pictures, it can be easily determined whether the skin is included in the subject picture. Also, since the light component having a wavelength which is not required for the detection can be cut by the infrared ray transmitting filter, the precision for detecting whether the skin is included in the subject picture can increase. Furthermore, since the near infrared rays are used, the skin can be detected even in a dark place and thus conventional imaging defects due to the near infrared rays can be compensated.

According to the second aspect of the invention, since it is determined whether the skin is photographed by the difference between the predetermined pixels of the subject pictures, it can be easily determined whether the skin is included in the subject picture. Furthermore, since the near infrared rays are used, the skin can be detected even in a dark place and thus conventional imaging defects due to the near infrared rays can be compensated.

According to the third aspect of the invention, although the filter for removing the visible light component is not provided when photographing the subject, the subject picture from which the visible light component is removed can be obtained and thus the number of the components and the cost can be reduced.

According to the fourth aspect of the invention, since the light component having a wavelength, which is not required for detecting the person from the subject picture, can be cut, the precision for detecting the person from the subject picture can increase.

According to the fifth aspect of the invention, since the location of the skin region can be detected, the location of the person can be detected.

According to the sixth aspect of the invention, since it is determined whether the skin is photographed by the difference between pixel values of the predetermined pixels of the subject pictures, it can be easily determined whether the skin is included in the subject picture. Furthermore, since the near infrared rays are used, the skin can be detected even in a dark place and thus conventional imaging defects due to the near infrared rays can be compensated.

### BRIEF DESCRIPTION OF THE DRAWINGS

These and other objects and advantages of this invention will become more fully apparent from the following detailed description taken with the accompanying drawings in which:

FIG. 1 is a side view of a self-propelled cleaner including a human body detecting device according to the present invention;

FIG. 2 is a plan view of a self-propelled cleaner including a human body detecting device according to the present invention;

FIG. 3 is a front view of a self-propelled cleaner including a human body detecting device according to the present invention;

FIG. 4 is a block diagram illustrating the structure of a self-propelled cleaner including a human body detecting device according to a first embodiment of the present invention;

FIG. 5 is a block diagram illustrating the structure of a storing unit of a self-propelled cleaner including a human body detecting device according to the first embodiment of the present invention;

FIG. 6 is a front view illustrating an arrangement of a light-emitting diode to a substrate in the first embodiment of the present invention;

FIG. 7 is a graph illustrating spectrum reflectance information;

FIG. 8 is a flowchart illustrating process flow until forming a subject image in the first embodiment of the present invention;

FIG. 9 is a flowchart illustrating process flow when detecting a human body in the first embodiment of the present invention;

FIG. 10 is a block diagram illustrating the structure of a self-propelled cleaner including a human body detecting device according to a second embodiment of the present invention;

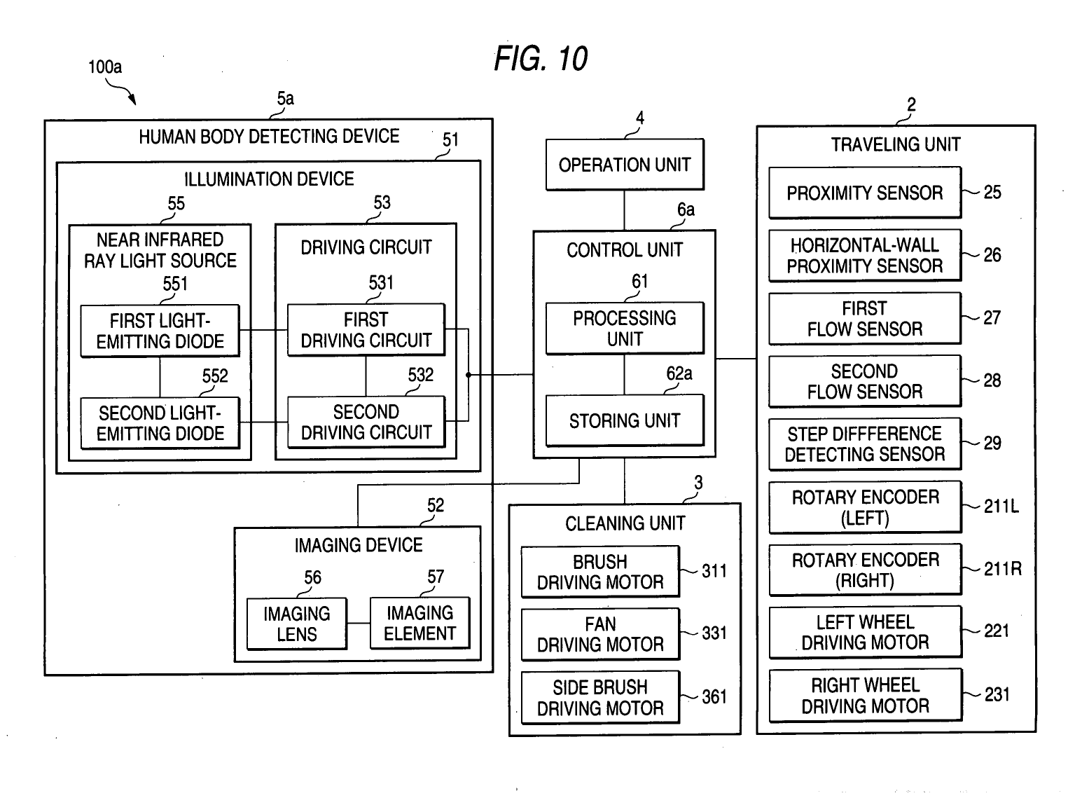

FIG. 11 is a block diagram illustrating the structure of a storing unit of a self-propelled cleaner including a human body detecting device according to the second embodiment of the present invention;

FIG. 12 is a flowchart illustrating process flow of obtaining a subject image in the second embodiment of the present invention; and

FIG. 13 is. a diagram illustrating a modification example using an illumination device according to the present invention as the other usage.

### DETAILED DESCRIPTION OF THE PREFERRED EMBODIMENTS

Hereinafter, a human body detecting device and a human body detecting method according to the present invention will be described in detail with reference to the accompanying drawings. Also, in embodiments, for example, a human body detecting device provided in a self-propelled cleaner will be exemplified.

### First Embodiment

Structure of Self-Propelled Cleaner

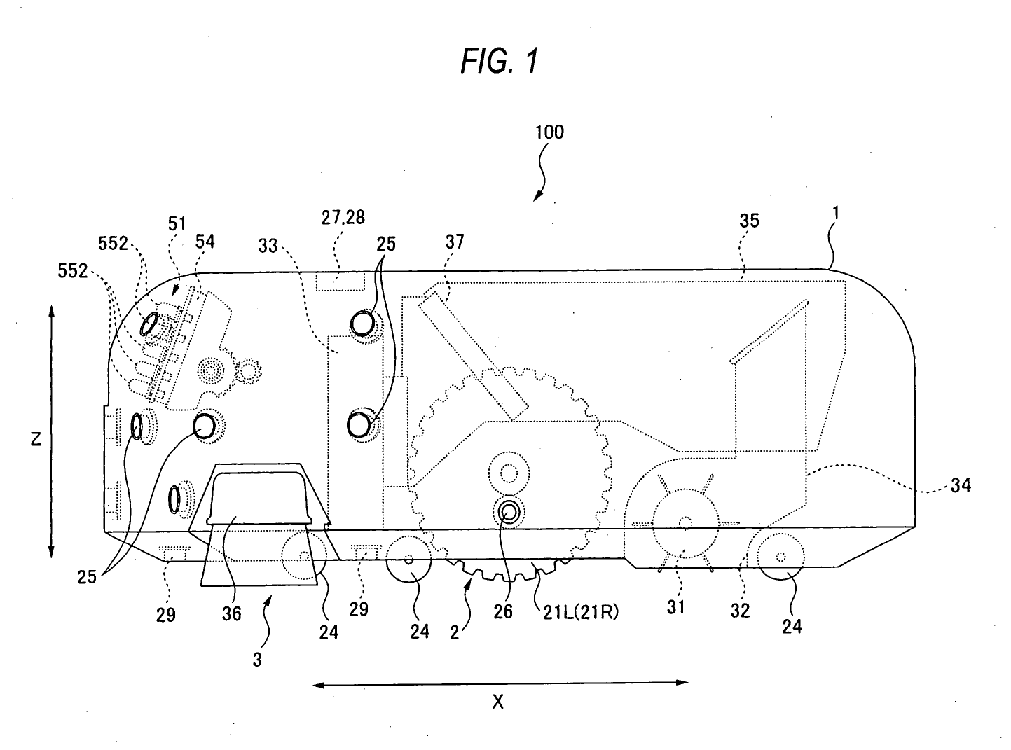

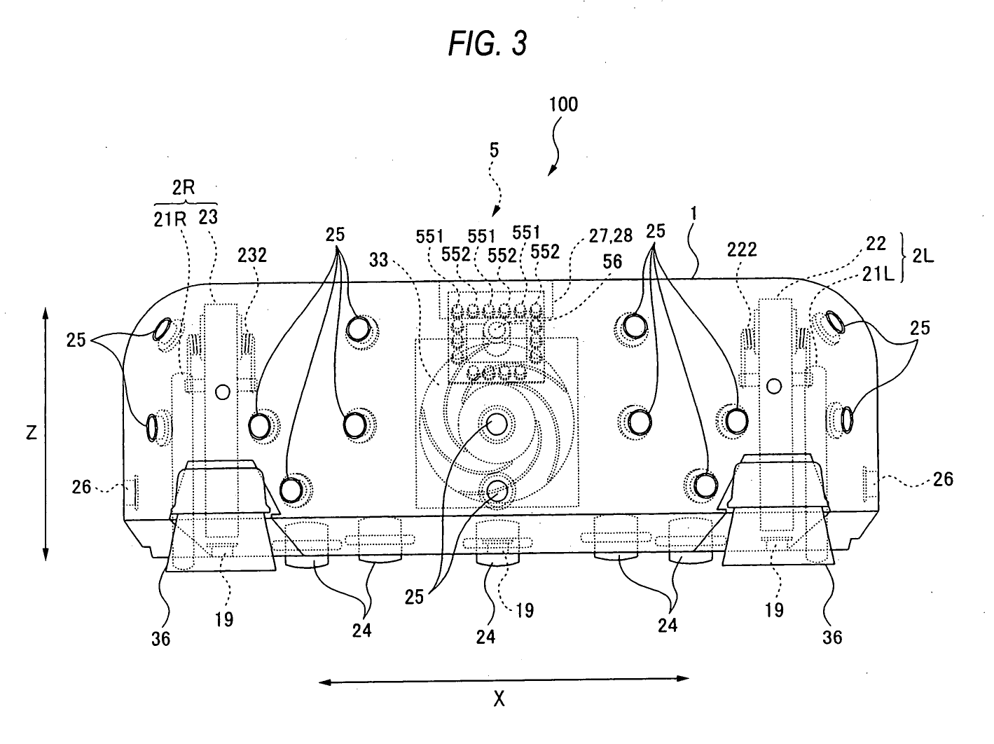

A self-propelled cleaner 100 (hereinafter, referred to as a cleaner 100) freely travels in a room according to a predetermined traveling pattern and performs the cleaning. As shown in FIGS. 1 to 5, the cleaner 100 includes a housing 1 which is cylindrical and has a closed upper surface, a traveling unit 2 which is installed inside of the housing 1 and moves the cleaner 100 in a desired direction, a cleaning unit 3 which cleans dust on a cleaned surface which is the traveling surface during the movement, an operation unit 4 for performing operation by a user, a human body detecting device 5 for detecting a person, and a control unit 6 for controlling the operation of each portion.

Housing

The housing 1 protects the traveling unit 2 or the control unit 6 from external impact or dust and is installed to cover the upper side or the lateral side of the traveling unit 2 or the control unit 6.

Traveling unit

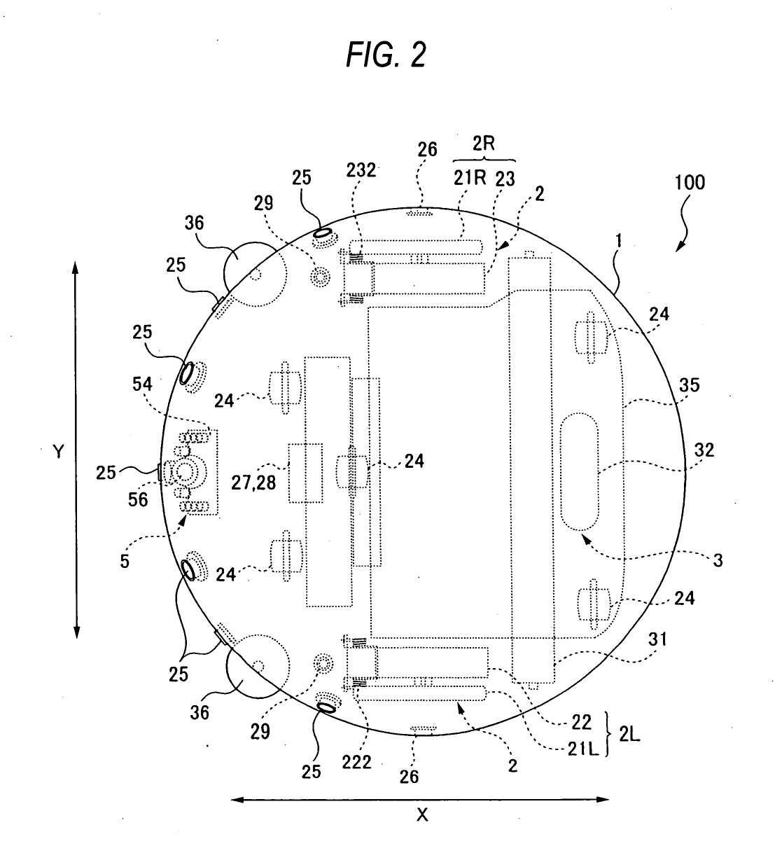

The traveling unit 2 includes left and right driving wheels 21L and 21R which are disposed at both ends in the traveling direction at substantially the center of the bottom of the cleaner 100, a left wheel driving unit (first driving unit) 22 and a right wheel driving unit (second driving unit) 23 for independently driving the driving wheels 21L and 21R, a predetermined number (five in FIG. 2) of vertically moving wheels 24 which vertically rotates according to the travel of the cleaner 100, a proximity sensor 25 which measures a distance from a forward direction obstacle such as a wall or furniture which exists in the forward direction, horizontal-wall proximity sensors 26 and 26 which measure a distance from an obstacle (backward direction obstacle) such as a horizontal wall which exists in a left and right direction Y of the cleaner 100, a first flow sensor 27 and a second flow sensor 28 which detect an air stream to detect the flow rate, and a step difference detecting sensor 29 for detecting a step difference such as unevenness which exists in the traveling surface.

The left driving wheel 21L is rotatably installed, for example, about the shaft of the left and right direction Y. Also, the left driving wheel 21L is provided with a rotary encoder 211L for outputting a rotation signal based on the rotation.

The left wheel driving unit 22 includes, for example, a left wheel driving motor 221 serving as a driving source for rotating the left driving wheel 21L and a driving force transmitting portion (not shown), such as a gear, for transmitting a driving force of the left wheel driving motor 221 to the left driving wheel 21L, and the left wheel driving unit 22 is integrated with the left driving wheel 21L to constitute the left wheel driving unit 2L.

Further, the left wheel driving unit 2L is supported by a unit supporting portion (not shown) fixed to the housing 1 in a state in which it is pressed to the traveling surface of the cleaner 100 by a pressing spring 222, and, more specifically, is connected to the unit supporting portion through a first link and a second link (not shown) rotatably attached to two different points of the left wheel driving unit 2L and the unit supporting portion.

The right driving wheel 21R is rotatably installed about the shaft of the left and right direction Y, similar to the left driving wheel 21L. Also, a rotary encoder 211R for outputting a rotation signal based on the rotation is disposed in the right driving wheel 21R.

The right wheel driving unit 23 has the same structure as the left wheel driving unit 22, and includes, for example, a right wheel driving motor 231 serving as a driving source for rotating the right driving wheel 21R and a driving force transmitting unit (not shown), such as a gear, for transmitting the driving force of the right wheel driving motor 231 to the right driving wheel 21R. The right wheel driving unit 23 is integrated with the right driving wheel 21R to constitute the right wheel driving unit 2R.

Further, the right wheel driving unit 2R is supported by an unit supporting portion (not shown) fixed to the housing 1 in a state in which it is pressed to the traveling surface of the cleaner 100 by a pressing spring 232, similar to the left wheel driving unit 2L, and, more specifically, is connected to the unit supporting portion through a first link and a second link (not shown) rotatably attached to two different points of the right wheel driving unit 2R and the unit supporting portion.

A predetermined number of the vertically moving wheels 24 are disposed at predetermined locations in consideration of weight balance on the basis of the driving wheels 21L and 21R of the cleaner 100 so as to increase travel stability according to the rotation of the driving wheels 21L and 21R.

The proximity sensor 25 is composed of, for example, an infrared ray sensor or an ultrasonic sensor, and is installed in plural so as to expose the front ends of the proximity sensors 25 through a plurality of openings provided at the front side of the housing 1.

Moreover, the proximity sensor 25 outputs to the control unit 6 a forward obstacle detecting signal for detecting a forward direction obstacle such as a wall or furniture which is located around the cleaner 100 in a forward direction and measuring a distance from the forward direction obstacle, under the control of the control unit 6. That is, the cleaner 100 executes a predetermined program based on the forward obstacle detecting signal output from the proximity sensor 25 for which the cleaner 100 travels, and thus the proximity sensor 25 detects the forward direction obstacle which is located in the forward direction of the cleaner 100.

The horizontal-wall proximity sensor 26 is composed of, for example, an infrared ray sensor or an ultrasonic sensor, similar to the proximity sensor 25, and is installed so as to expose the front ends of the horizontal-wall proximity sensors 26 through two openings provided in the ends of the left and right driving wheels 21L and 21R of the housing 1.

Moreover, the horizontal-wall proximity sensor 26 outputs to the control unit 6 a backward obstacle detecting signal for detecting an obstacle such as a wall or furniture which is located in a direction approximately perpendicular to the forward direction, that is, a backward direction obstacle which is located in the backward direction of the cleaner 100 in the below-described backward driving control and measuring a distance from the backward direction obstacle, under the control of the control unit 6. That is, after the driving stopping control, the cleaner 100 executes a predetermined program, based on the backward obstacle detecting signal output from the horizontal-wall proximity sensor 26, and thus the horizontal-wall proximity sensor 26 detects the backward direction obstacle which is located in the backward direction of the cleaner 100.

The first flow sensor 27 and the second flow sensor 28 are provided at substantially the center of the upper surface of the cleaner 100. Concretely, the first flow sensor 27 and the second flow sensor 28 are disposed in a predetermined direction to expose the detecting units from the housing 1 such that the first flow sensor 27 detects an air stream which flows in the forward direction according to a predetermined traveling pattern of the cleaner 100 and the second flow sensor 28 detects an air stream which flows in the direction perpendicular to the forward direction.

Furthermore, while the cleaner 100 travels (moves), the first flow sensor 27 outputs to the control unit 6 a first flow rate signal according to the flow rate of the air stream which flows in the forward direction, and the second flow sensor 28 outputs to the control unit 6 a second flow rate signal according to the flow rate of the air stream which flows in the direction perpendicular to the forward direction. More specifically, the first flow sensor 27 and the second flow sensor 28 include temperature detecting units such as macro sensors. After the temperature detecting unit detects the temperature reduced by the air stream generated during the travel, the flow rates of the air streams which flow in the forward direction and the direction perpendicular to the forward direction, that is, moving speeds of the cleaner 100, having a predetermined relationship with the reduced degree of the detected temperature, are calculated and are output to the control unit 6 as the first flow rate signal and the second flow rate signal.

Here, when at least one of the first flow rate signal output from the first flow sensor 27 and the second flow rate signal output from the second flow sensor 28 is input to the control unit 6, the control unit 6 detects the moving direction of the cleaner 100 according to the execution of a predetermined operation program, based on at least one of the first flow rate signal and the second flow rate signal. Further, the control unit 6 controls the driving of the left wheel driving motor 221 and the right wheel driving motor 231 such that the cleaner 100 moves according to a predetermined traveling pattern by executing the predetermined control program based on the detected moving direction.

The step difference detecting sensor 29 is composed of an infrared sensor or an ultrasonic sensor, similar to the proximity sensor 25 and the horizontal-wall proximity sensor 26, and is installed at the front sides of the left and right driving wheels 21L and 21R and the front end of the bottom so that the front end of the step difference detecting sensor 29 is disposed toward the traveling surface. Also, the step difference detecting sensor 29 outputs a step difference detecting signal for detecting a step difference which exists in the traveling surface to the control unit 6.

Cleaning Unit

The cleaning unit 3 includes a cleaning brush 31 for sweeping dust on a cleaning surface (traveling surface), an absorbing fan 33 for collecting the dust on the cleaning surface through an absorbing port 32, a dust collector 35 for communicating with the absorbing port 32 through a communication portion 34 and collecting the dust absorbed through the absorbing port 32, and a side cleaning brush 36 for cleaning a cleaning surface which is located at the outside of the cleaning surface of the cleaning brush 31.

The cleaning brush 31 freely rotates about the shaft of the left and right direction Y by rotating a brush driving motor 311 under the control of the control unit 6. Also, the absorbing port 32 is installed at the back of the cleaning brush 31.

The absorbing port 32 is installed at substantially the center of the longitudinal direction of the cleaning brush 31, and is connected to the back end of the dust collector 35 through the communication portion 34.

The absorbing fan 33 communicates with the front end of the dust collector 35 through a filter 37 for filtering the dust, and rotates by rotating a fan driving motor 331 under the control of the control unit 6.

The side cleaning brush 36 is installed at the front sides of the left and right driving wheels 21L and 21R such that a portion of the brush protrudes more to the outside than the housing 1. That is, the side cleaning brush 36 rotates about the shaft of a top and bottom direction Z which is provided at the edge of the housing 1 by rotating a side brush driving motor 361, under the control of the control unit 6. Accordingly, a portion, for example, half of the side cleaning brush 36 is located at the outside of the housing 1 and thus cleans the dust which exists in the cleaning surface which is located at the outside of the cleaning surface of the cleaning brush 31.

Operation Unit

The operation unit 4 has, for example, a plurality of operation keys (not shown) for instructing the execution of various functions of the cleaner 100, and outputs a predetermined operation signal corresponding to an operation key operated by a user to the control unit 6.

Human Body Detecting Device

The human body detecting device 5 photographs the state of a room in which the cleaner 100 is laid down, and detects whether a skin is included in the photographed picture. The human body detecting device 5 includes an illumination device 51 having near infrared ray light sources 55 for emitting near infrared rays having different wavelengths and an imaging device 52 for photographing a subject, as shown in FIGS. 1 to 4.

The illumination device 51 includes a driving circuit 53 connected to the control unit 6, a substrate 54 connected to the driving circuit 53, and a plurality of kinds of near infrared ray light sources 55 which have different wavelengths and are integrally held on the substrate 54, as shown in FIGS. 1 to 4.

The near infrared ray light source 55 is composed of, for example, light-emitting diodes, and include a plurality of first light-emitting diodes 551 having a short light emitting wavelength smaller than 900 nm and a plurality of second light-emitting diodes 552 having a central light emitting wavelength of 900 to 1000 nm.

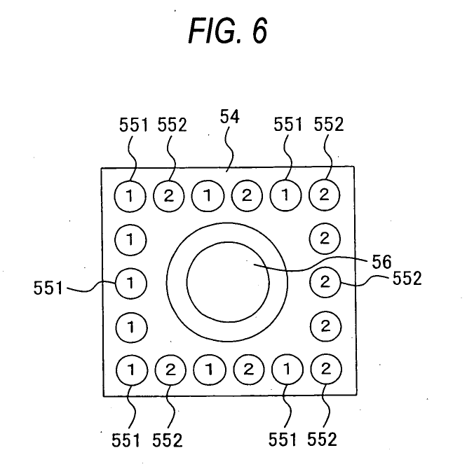

As shown in FIG. 6, the light-emitting diodes 551 and 552 are repeatedly disposed on the substrate 54 in the horizontal direction, and are repeatedly disposed in the vertical direction, except for a region in which the imaging device 52 is provided.

The driving circuit 53 includes a first driving circuit 531 for supplying a current in order to allow the first light-emitting diodes 551 to emit light by the control signal from the control unit 6 and a second driving circuit 532 for supplying a current in order to allow the second light-emitting diodes 552 to emit light by the control signal from the control unit 6. That is, the driving circuit is provided for each kind of the light-emitting diode and the light-emitting diodes for emitting light having the same wavelength are simultaneously turned on by the control signal from the control unit 6.

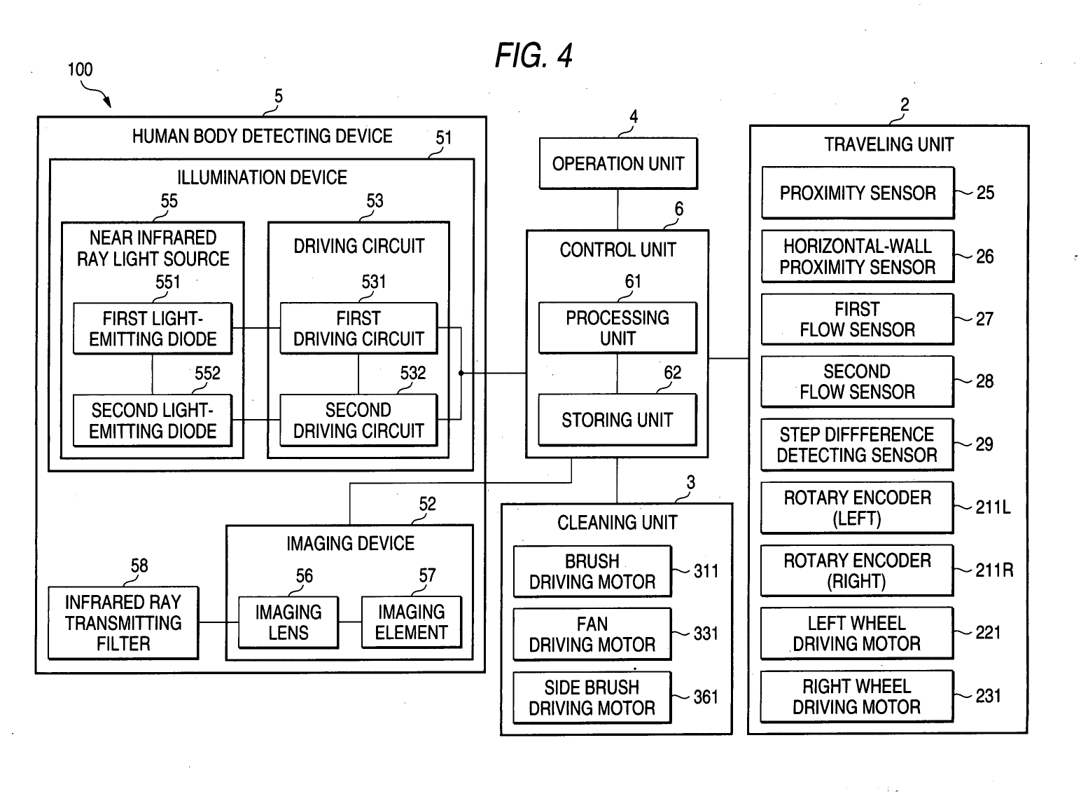

As shown in FIG. 4, the imaging device 52 includes an imaging lens 56 for converging light which is emitted from the near infrared ray light sources 55 and is reflected from the subject and forming a subject image, and an imaging element 57 which has light receiving sensitivity in a near infrared ray region and forms a subject picture based on the subject image formed by the imaging lens 56.

The imaging lens 56 is disposed to form an image on a light receiving surface of the imaging element 57 and is composed of a convex lens, a concave lens, or a combination thereof.

The imaging element 57 is composed of a CCD (charge coupled device) or a CMOS (complementary metal oxide semiconductor), and photographs a front photographing target range of the imaging lens 56 according to the control of the control unit 6. In more detail, the image input through the imaging lens 56 is converted into an electric signal by the CMOS, is converted into picture data as a digital signal by an A/D converter, and is output to the control unit 6.

Furthermore, an infrared ray transmitting filter 58 is provided in the human body detecting device 5. The infrared ray transmitting filter 58 cuts light having a wavelength called visible light rays and transmits only the near infrared rays. This filter serves to remove light emitted from a fluorescent lamp in a room and increase precision for detecting a person.

Control Unit

The control unit 6 includes a processing unit 61 for performing various operation processes and a storing unit 62 which is used as a work area of the processing unit 61 and stores a system program required for controlling each portion by the processing unit 61.

The processing unit 61 is composed of a CPU, reads and develops the program stored in the storing unit 62, and performs the control on the transmission/reception of data or an instruction transmitted to each portion based on the program.

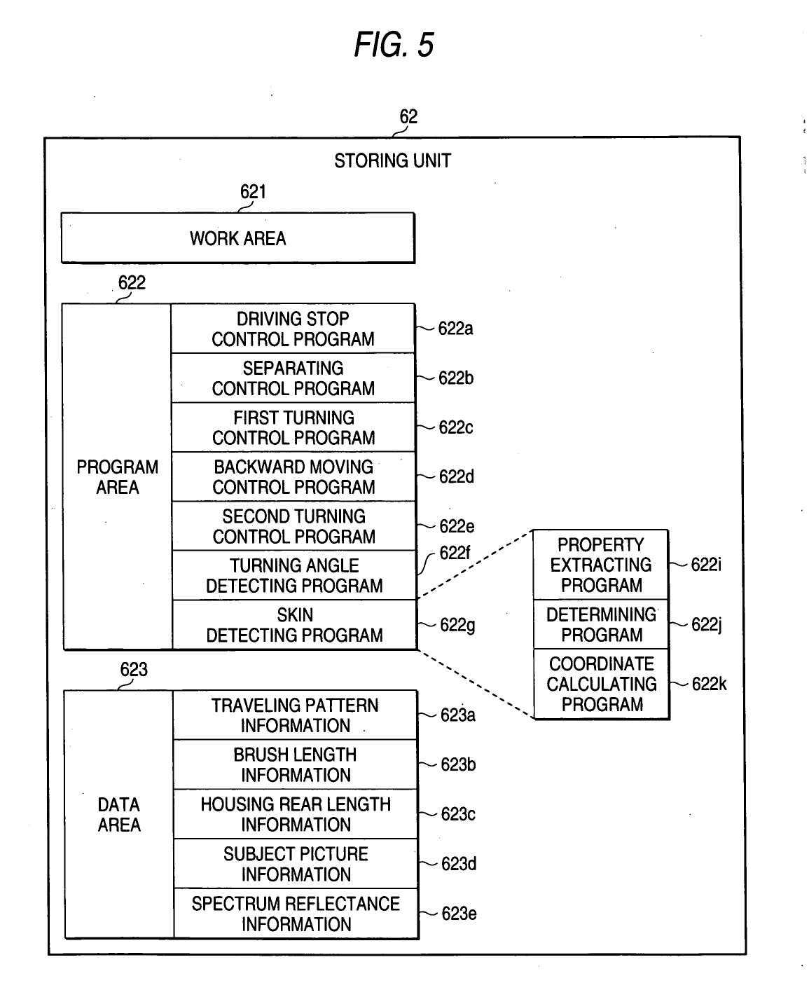

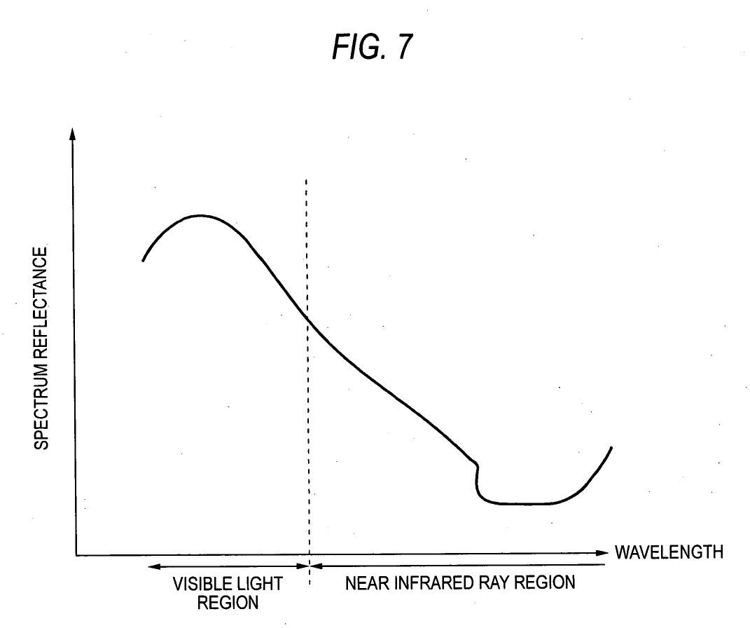

As shown in FIG. 5, the storing unit 62 is composed of a RAM or a ROM, and includes a work area 621 which functions as a work area of the processing unit 61, a program area 622 for storing a program executed in the processing unit 61, and a data area 623 for storing the subject picture formed by the imaging element 57 or spectrum reflectance information. Here, the spectrum reflectance information is information obtained by associating the wavelength of the near infrared ray with the spectrum reflectance of the person's skin, as shown in FIG. 7.

Specifically, a driving stop control program 622a for realizing a driving stop control function for stopping the driving of the left wheel driving unit 22 and the right wheel driving unit 23 so as to stop the traveling cleaner 100 at a predetermined travel stop location is stored in the program area 622. Here, the processing unit 61 executes the driving stop control program 622a, so that the control unit 6 functions as a driving stop control unit. Concretely, the driving stop control for stopping the driving of the left wheel driving unit 22 and the right wheel driving unit 23 to stop the cleaner 100 at a location which does not contact with the forward direction obstacle, and more preferably, at a location which is slightly separated from the forward direction obstacle is executed.

Further, a separating control program 622b for realizing a separating drive control function for driving the left wheel driving unit 22 and the right wheel driving unit 23 such that the cleaner moves in a direction which the cleaner is separated from the forward direction obstacle, that is, a backward direction after the driving stop control is stored in the program area 622. Here, the processing unit 61 executes the separating control program 622b, so that the control unit 6 functions as a separating control unit. Concretely, the distance separated from the forward direction obstacle is calculated by the control unit 6 based on the distance from the travel stop location of the cleaner 100, that is, from the front end of the cleaner 100 to the forward direction obstacle, and a turning radius according to first turning driving control.

Furthermore, a first turning control program 622c for realizing a first turning drive control function for driving any one of the left wheel driving unit 22 and the right wheel driving unit 23 such that the cleaner 100 turns by 90 degrees about any one shaft of the left and right driving wheels 21L and 21R toward the forward direction of the cleaner 100 after the separating driving control is stored in the program area 622. Here, the processing unit 61 executes the first turning control program 622c, so that the control unit 6 functions as a first turning control unit.

Also, a backward moving control program 622d for realizing a backward moving drive control function for driving the left wheel driving unit 22 and the right wheel driving unit 23 such that the cleaner moves backward by a predetermined distance after the first turning drive control is stored in the program area 622. Here, the processing unit 61 executes the backward moving control program 622d, so that the control unit 6 functions as a backward moving control unit. Concretely, in the backward moving drive control, when the backward direction obstacle does not exist within a predetermined distance (for example, equal to a rear length (described below) of the housing) from the cleaner 100 in the backward direction, that is, when the backward direction obstacle is not detected, brush length information 623b (described below) is read from the data area 623 by allowing the processing unit 61 to execute the backward direction control program 622d, and the backward moving drive control is executed such that the cleaner moves backward by the brush length based on the brush length information 623b. Also, in the backward moving driving control, when the backward direction obstacle exists in the backward direction of the cleaner 100, that is, when the backward direction obstacle is detected, the housing rear length information 623c (described below) is read from the data area 623 according to the execution of the backward direction control program 622d by the processing unit 61 and the backward moving drive control is executed such that the cleaner moves backward by the rear length of the housing based on the housing rear length information 623c.

Moreover, a second turning control program 622e for realizing a second turning drive control function for driving any one of the left wheel driving unit 22 and the right wheel driving unit 23 such that the cleaner 100 turns by 90 degrees in a turning direction equal to that according to the first turning drive control after the backward moving drive control is stored in the program area 622. Here, the processing unit 61 executes the second turning control program 622e, so that the control unit 6 functions as a second turning control unit.

Also, a turning angle detecting program 622f for realizing a turning angle detecting function for detecting a turning angle of the cleaner 100 based on a rotation signal output from the rotary encoders 211L and 211R which are provided in the left and right driving wheels 21L and 21R which rotates in at least the first turning drive control and the second turning drive control is stored in the program area 622. Here, the processing unit 61 executes the turning angle detecting program 622f, so that the control unit 6 functions as a turning angle detecting unit.

Furthermore, a skin detecting program 622g for detecting whether a skin is included in the subject picture stored in the storing unit 62 is stored in the program area 622. Here, the processing unit 61 executes the skin detecting program 622g, so that the control unit 6 functions as a skin detecting unit. This skin detecting program 622g includes a property extracting program 622i, a determining program 622j, and a coordinate calculating program 622k.

The property extracting program 622i performs a function for extracting a difference between pixel values of the subject pictures photographed for each of the wavelengths (two kinds) of the near infrared rays which are stored in the data area 623. Here, the processing unit 61 executes the property extracting program 622i, so that the control unit 6 functions as a property extracting unit. The difference between the pixel values includes, for example, a change amount (slope) of the pixel values for a wavelength change amount or a difference between the pixel values.

The determining program 622j allows the processing unit 61 to compare the difference between the pixel values extracted by executing the property extracting program 622i with the spectrum reflectance information stored in the data area 623 of the storing unit 62 to realize a function of determining whether the pixels of a predetermined location correspond to the skin. Concretely, when the result of comparing the difference between the pixel values of the subject pictures with the spectrum reflectance information is in an allowable range that both of them is recognized to be approximate, the pixel is a candidate skin region. When the candidate pixels occupy a predetermined region, they are determined to be a skin region. Here, the processing unit 61 executes the determining program 622j, so that the control unit 6 functions as a determining unit.

The coordinate calculating program 622k performs a function for calculating coordinates of a skin region, which it is recognized that the skin is photographed, in the subject picture. Here, the processing unit 61 executes the coordinate calculating program 622k, so that the control unit 6 functions as a coordinate calculating unit. Thus, by the skin region, it is determined that the person exists and the location of the person can be detected by calculating the coordinates of the skin region. Here, the processing unit 61 executes the coordinate calculating program 622k, so that the control unit 6 functions as the coordinate calculating unit.

The traveling pattern information 623a according to a predetermined traveling pattern of the cleaner 100 is stored in the data area 623 as a traveling pattern storing unit. Here, as the traveling pattern, the two driving wheels 21L and 21R rotate at substantially the same speed, so that the cleaner straightly travels toward a predetermined direction and the forward direction obstacle is detected based on the output signal from the proximity sensor 25 for which the cleaner travels. In this case, the cleaner is stopped, makes a U-turn, that is, turns by 180 degrees and then straightly travels toward a direction opposite to a predetermined direction. At this time, the cleaner repeatedly performs this operation in this order.

Moreover, the traveling pattern may be set based on a predetermined operation of the operation unit 4 by the user or previously set as a default in the manufacturing and shipping steps.

Also, the brush length information 623b according to the brush length of the left and right direction Y perpendicular to the traveling direction of the cleaning brush 31 is stored in the data area 623 as the brush length information storing unit. Also, the cleaning brush 31 is disposed over the left and right direction Y of the cleaner 100 and the length of the brush approximately corresponds to one body length of the front and rear direction X of the cleaner 100 which is approximately circular in plan view.

Further, the housing rear length information 623c according to the housing rear length along the front and rear direction X (traveling direction) of the backward direction of the left and right driving wheels 21L and 21R of the housing 1 is stored in the data area 623 as the rear length information storing unit. Also, since the left and right driving wheels 21L and 21R are provided at the approximately center of the circular cleaner 100 in plan view, the housing rear length approximately corresponds to half of the body length of the front and rear direction X of the cleaner 100.

Also, subject picture information 623d related to the picture photographed by the imaging device 52 is stored in the data area 623.

Further, spectrum reflectance information 623e related to the spectrum reflectance of the person's skin is stored in the data area 623.

Human Body Detecting Process

Hereinafter, a human body detecting process performed by the human body detecting device 5 will be described.

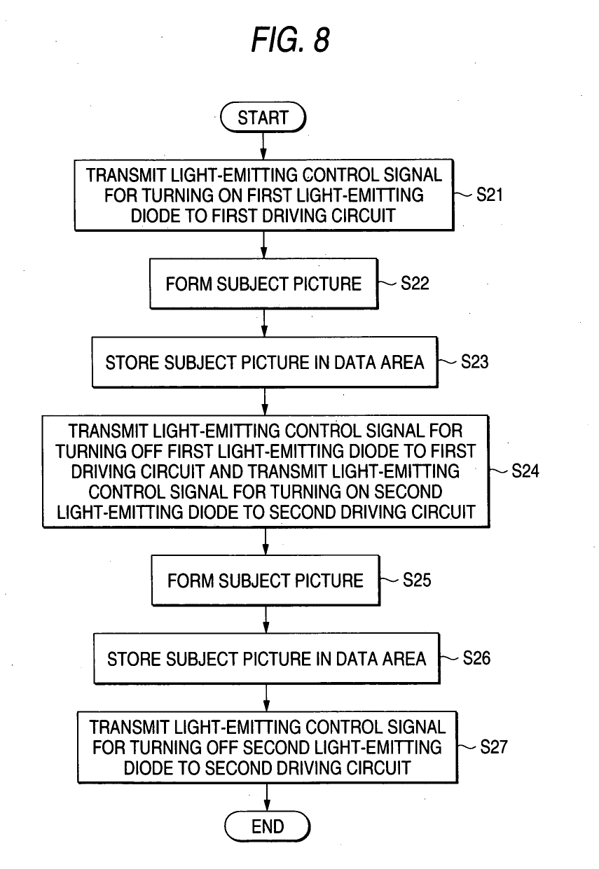

As shown in FIG. 8, when the processing unit 61 transmits a light emitting control signal for allowing the first light-emitting diode 551 to emit the light to the first driving circuit 531 (step S21), the first driving circuit 531 supplies a current to the first light-emitting diode 551 and thus the first light-emitting diode 551 emits the light to irradiate the light onto the subject (irradiating process).

The near infrared rays emitted from the first light-emitting diode 551 reaches the subject and a portion thereof is reflected from the subject. The reflected light and the visible light pass through the infrared ray transmitting filter 58, so that only the near infrared rays are transmitted and the visible light rays are cut. The near infrared rays having transmitted the infrared ray transmitting filter 58 are converged by the imaging lens 56 and reaches the imaging element 57 to form the subject picture (step S22) (photographed picture forming process). Further, the processing unit 61 stores the subject picture in the data area 623 of the storing unit 62 (step S23) (storing process).

Subsequently, when the processing unit 61 transmits a light emitting control signal that turns off the first light-emitting diode 551 and allows the second light-emitting diode 552 to emit the light to the first driving circuit 531 (step S24), the first driving circuit 531 stops supplying a current to the first light-emitting diode 551 and the second driving circuit 532 supplies a current to the second light-emitting diode 552. Thus, the second light-emitting diode 552 emits the light to irradiate the light onto the subject (irradiating process).

The near infrared rays emitted from the second light-emitting diode 552 reaches the subject and a portion thereof is reflected from the subject. The reflected light and the visible light pass through the infrared ray transmitting filter 58, so that only the near infrared rays is transmitted and the visible light is cut. The near infrared rays having transmitted the infrared ray transmitting filter 58 are converged by the imaging lens 56 and reaches the imaging element 57 to form the subject picture (step S25) (photographed picture forming process). Further, the processing unit 61 stores the subject picture in the data area 623 of the storing unit 62 (step S26) (storing process).

Subsequently, when the processing unit 61 transmits a light emitting control signal that turns off the second light-emitting diode 552 to the second driving circuit 532 (step S27), the second driving circuit 532 stops supplying the current to the second light-emitting diode 552. Thus, the second light-emitting diode 552 is turned off and thus the present process is finished.

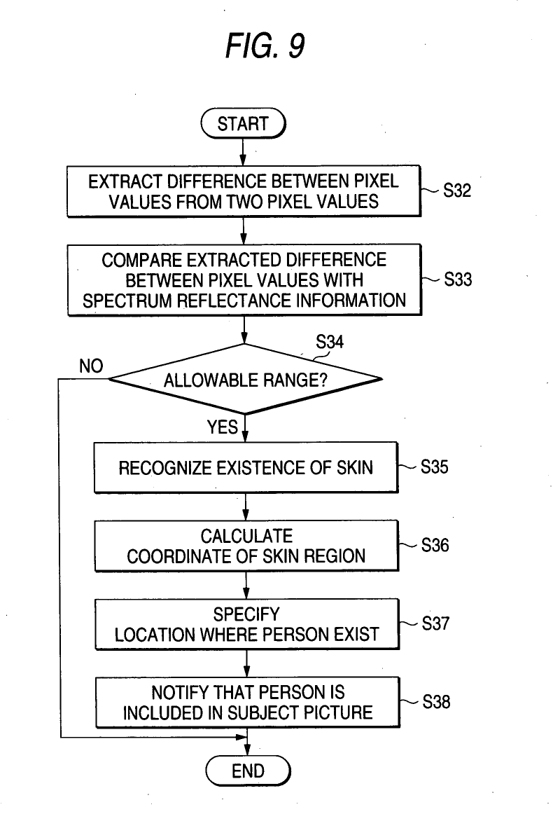

Subsequently, as shown in FIG. 9, the processing unit 61 executes the property extracting program 622i to extract the difference between the pixel values of at the same location of the subject pictures photographed for each of the wavelengths of the near infrared rays which are stored in the data area 623 (step S32) (property extracting process). Subsequently, the processing unit 61 executes the determining program 622j to read the spectrum reflectance information stored in the data area 623 and compares the difference between the pixel values extracted by executing the property extracting program 622i by the processing unit 61 with the spectrum reflectance information stored in the data area 623 of the storing unit 62 (step S33). Also, it is determined whether the result of comparing the difference between the pixel values of the subject pictures with the spectrum reflectance information is in an allowable range that both of them is recognized to be approximate (step S34). Here, if the processing unit 61 determines that the result of comparing the difference between the pixel values of the subject pictures with the spectrum reflectance information is in an allowable range that both of them is recognized to be approximate (step S34: YES), the processing unit 61 set the pixel to the candidate skin region. When the candidate pixels occupy a predetermined region, the region is determined to the skin region (step S35).

Subsequently, the processing unit 61 calculates coordinates of the skin region, in which it is recognized that the skin is photographed, in the subject picture (step S36) and specifies the location of the person from the coordinates of the calculated skin region (step S37). Also, the processing unit 61 notifies a user or a manager that the skin is photographed and a place where a person having the skin is located through the communication portion (step S38). Thus, the present process is finished.

On the other hand, if the processing unit 61 determines that the result of comparing the difference between the pixel values of the subject pictures with the spectrum reflectance information is not in an allowable range that both of them is recognized to be approximate (step S34: NO), the processing unit 61 finishes the present process.

As described above, according to the human body detecting device 5 and the human body detecting method using the human body detecting device 5 of the present invention, when each of the light-emitting diodes 551 and 552 emits the light to the subject, the visible light rays of the light reflected from the subject after reaching the subject are cut by the infrared ray transmitting filter 58, and only the near infrared rays are converged by the imaging lens 56 to form the subject picture. The imaging element 57 having the light receiving sensitivity in the near infrared ray region forms the subject picture based on the subject image formed by the imaging lens 56, and the subject picture is stored in the data area 623 of the storing unit 62.

Here, when it is determined whether the skin is included in the subject image, the processing unit 61 executes the property extracting program 622i included in the skin detecting program 622g to extract the difference between the pixel values at the same location of the subject pictures photographed for each of the wavelengths of the light-emitting diodes 551 and 552. Also, the processing unit 61 executes the determining program 622j included in the skin detecting program 622g to compare the difference between the pixel values of the subject pictures extracted by executing the property extracting program 622i with the spectrum reflectance information stored in the data area 623 of the storing unit 62 and determines whether the result of comparing the difference between the pixel values of the subject pictures with the spectrum reflectance information is in an allowable range that both of them is recognized to be approximate. Here, when the processing unit 61 determines that the result of comparing the difference between the pixel values of the subject pictures with the spectrum reflectance information is in an allowable range that both of them is recognized to be approximate, the processing unit 61 set the pixel to a candidate skin region. When the candidate pixels occupy a predetermined region, they are determined to be a skin region. Also, the processing unit 61 calculates coordinates of the skin region of the subject picture and specifies the location of the person from the calculated coordinate.

Thus, the skin can be detected from the pixel value of the subject picture. Also, the location of the person can be detected by obtaining the coordinates of the skin region. Further, since the light component having a wavelength which is not required for the detection can be cut using the infrared ray transmitting filter 58, the precision for detecting the existence of the person from the subject picture can increase. Moreover, since the near infrared rays are used, the skin can be detected in a dark place and the conventional imaging defects due to the near infrared rays can be compensated.

Furthermore, according to the illumination device 51 provided in the human body detecting device 5, since two kinds of the light-emitting diodes 551 and 552 having the different wavelengths are provided in plural and the driving circuits 531 and 532 are provided for each kind of the wavelength, the control unit 6 controls the driving circuits 531 and 532 to separately emit the light for each wavelength. Thus, the picture is formed using the light-emitting diodes 551 and 552 each having the different wavelength based on the plurality of the near infrared rays and thus a multi-spectrum picture can be obtained. Accordingly, since the picture is formed using the light-emitting diodes 551 and 552 each having the different wavelength based on the plurality of the near infrared rays, the information amount of the picture formed by the near infrared rays can increase and the recognizing process based on the reflection spectrum of the subject, such as color photographing of the visible light rays, can be performed.

Moreover, since the light-emitting diodes 551 and 552 which emit the light with the different wavelengths are provided in plural, each of the light-emitting diodes 551 and 552 may controlled only by the ON/OFF of a power supply and the wavelength does not need to change when the light is emitted. Accordingly, it is possible to allow the light-emitting diodes 551 and 552 having a plurality of wavelengths to emit light with the simpler structure and a lower cost as compared to the related art.

### Second Embodiment

Next, a human body detecting device and a human body detecting method according to a second embodiment of the present invention will be described. The present embodiment is different from the first embodiment in that a function for removing influence due to a visible light component of the picture data of the subject picture is provided. Thus, only the portion of the second embodiment different from the first embodiment will be described. The same components as the first embodiment are denoted by the same references and thus their description will be omitted.

Program Area

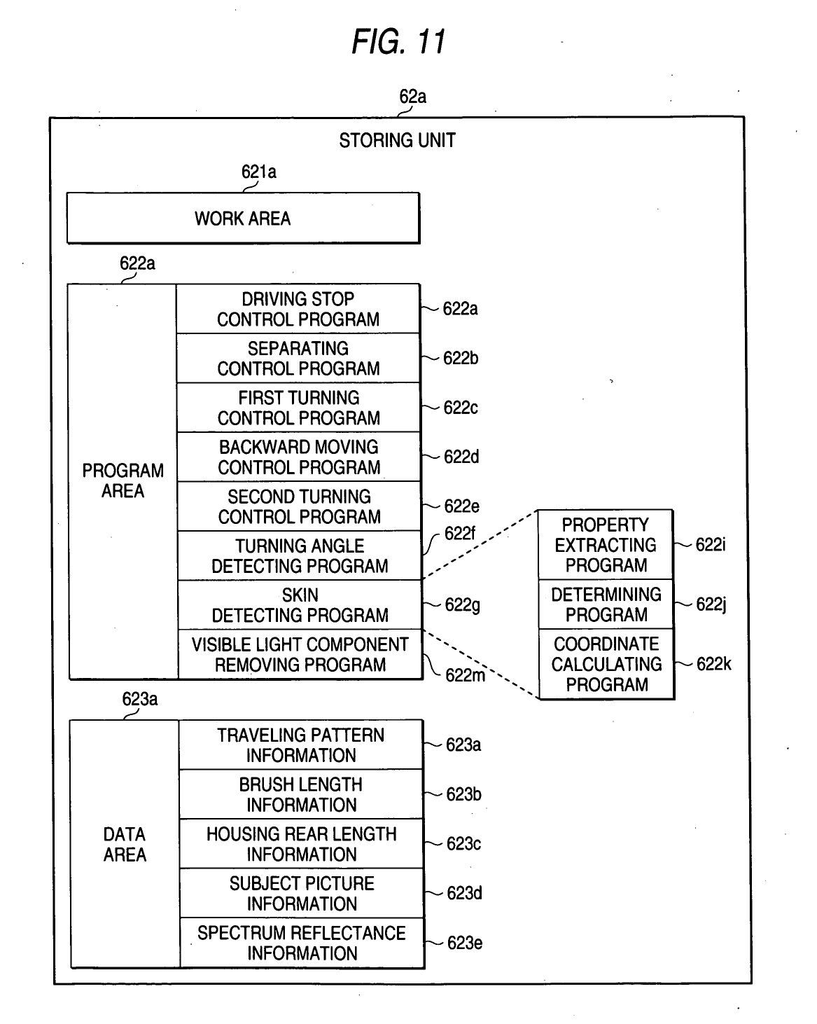

As shown in FIG. 11, a visible light component removing program 622m for realizing a function for removing influence due to the visible light component of picture data of the subject picture by subtracting picture data of a second subject picture photographed without emitting the light to the subject by the light-emitting diodes 551 and 552 from picture data of a first subject picture photographed by emitting the light to the subject by the light-emitting diodes 551 and 552 is stored in the program area 622a of the second embodiment. Here, the processing unit 61 executes the visible light component removing program 622m, so that the control unit 6a functions as a visible light component removing unit.

Data Area

Furthermore, subject picture information (picture data) related to the first subject picture photographed by emitting the light to the subject by the light-emitting diodes 551 and 552 and subject picture information (picture data) related to the second subject image photographed without emitting the light to the subject by the light-emitting diodes 551 and 552 are stored in the data area 623a of the second embodiment.

As described above, the control unit 6 executes the visible light component removing program 622m to obtain the subject picture excluding the visible light component, so that the infrared ray transmitting filter 58 does not need to be provided, unlike the first embodiment. Any one of the visible light component removing program 622m and the infrared ray transmitting filter 58 may be provided and both of them may be provided. This is available when the visible light is strong as the imaging element 57 is saturated. Also, since the visible light component can be removed through the two steps by this structure, a more accurate subject image can be obtained.

Process of Obtaining Subject Image

Hereinafter, a process of obtaining the subject picture by the visible light component removing program 622m will be described.

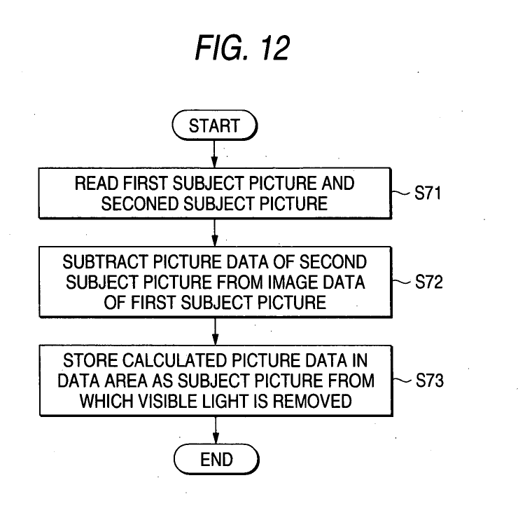

As shown in FIG. 12, the processing unit 61 executes the visible light component removing program 622m to read the first subject image and the second subject image from the data area 623a and develops the picture data to the work area 621a (step S71).

Subsequently, the processing unit 61 subtracts the picture data of the second subject picture from the picture data of the first subject picture (step S72).

Subsequently, the processing unit 61 stores the picture data calculated by the operation in the data area 623a as the subject picture from which the visible light component is removed (step S73) and the present process is finished.

Also, after forming the subject image, the skin is detected by the same process as the first embodiment.

As described above, according to the human body detecting device 5 of the second embodiment, in addition to the effect of the first embodiment, the processing unit 61 executes the visible light component removing program 622m to subtract picture data of a second subject picture photographed without emitting the light to the subject by the light-emitting diodes 551 and 552 from picture data of a first subject picture photographed by emitting the light to the subject by the light-emitting diodes 551 and 552. Thus, the picture data of the subject picture is influenced only by the irradiation of the light-emitting diodes 551 and 552, not the visible light component.

Thus, although a filter for removing the visible light component is not provided when photographing the subject, it is possible to obtain the subject picture from which the visible light component is removed. Therefore, the reduction of the number of the components and the reduction of the manufacturing cost can be realized.

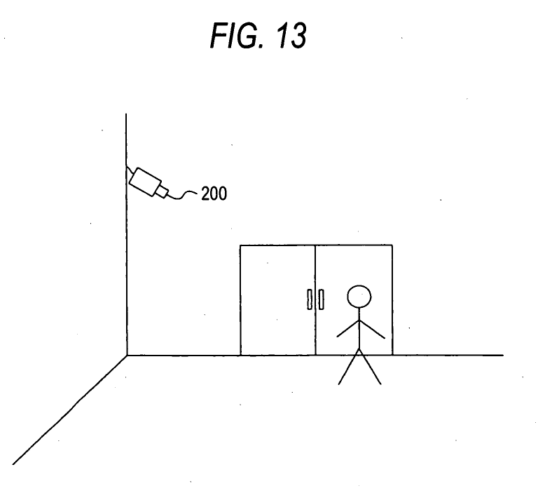

Further, the present invention is not limited to the above-mentioned embodiments. For example, the human body detecting device may not be provided in the cleaner and may be used as a single element. Specifically, as shown in FIG. 13, the human body detecting device 5 may be adhered to a monitoring camera 200 installed at an entrance of a building. That is, the illumination devices 51 and 51a are provided in the monitoring camera, and the monitoring camera 200 may perform the photography of the subject picture by the imaging device 52. Thus, the monitoring camera can detect whether the person is at the entrance of the building. Accordingly, a guard does not need to always monitor through a video whether the person is displayed by the monitoring camera. Accordingly, the burden of the guard can be reduced.

Moreover, the plurality of kinds of the light-emitting diodes can be disposed in any sequence. Also, the kinds of the light-emitting diodes are not limited to two kinds, but may be three kinds. That is, if the kinds of the light-emitting diodes are plural, the number of the kinds of the light-emitting diodes may be arbitrary. For example, as the kinds of the light-emitting diodes increase, the processing speed becomes decrease, but the skin detecting precision is improved. Accordingly, the kind of the light-emitting diode may be changed in accordance with the place or condition using the present device. Also, if the light-emitting diodes are uniformly dispersed on the substrate, any arrangement method may be used. That is, it is preferable that the light-emitting diodes be disposed such that the sensitivity of the illumination devices 51 and 51a is uniform.

Furthermore, the infrared ray transmitting filter 58 may be installed in the imaging device 52.

Also, the storing unit may be a storing medium which can be attached and detached to and from the human body detecting device. In addition, the present invention can be freely changed or modified without departing from the sprit and scope of the present invention.

What is claimed is:

1. A human body detecting device for detecting whether a person is included in a photographed image, comprising:
a plurality of near infrared ray light sources having different wavelengths;
an imaging lens which converges light which is emitted from the near infrared ray light sources and reflected from a subject to form a subject image;
an imaging element which has light receiving sensitivity in a near infrared ray region and forms a subject picture based on the subject image formed by the imaging lens;
an infrared ray transmitting filter which cuts visible light rays;
a storing unit which stores the subject picture formed by the imaging element and spectrum reflectance information obtained by associating the wavelengths of the near infrared rays with the spectrum reflectance of the person's skin;
a property extracting unit which extracts a difference between pixel values of predetermined pixels of the subject pictures photographed for each wavelength of the near infrared rays; and
a determining unit which determines whether the pixel corresponds to the skin by comparing the difference between the pixel values extracted by the property extracting unit with the spectrum reflectance information, and decides a region where the pixels corresponding to the skin intensively occupy a predetermined area to a skin region.

2. A human body detecting device for detecting whether a person is included in a photographed image, comprising:
a plurality of near infrared ray light sources having different wavelengths;
an imaging lens which converges light which is emitted from the near infrared ray light sources and reflected from a subject to form a subject image;
an imaging element which has light receiving sensitivity in the near infrared ray region and forms a subject picture based on the subject image formed by the imaging lens;
a storing unit which stores the subject picture formed by the imaging element and spectrum reflectance information obtained by associating the wavelengths of the near infrared rays with the spectrum reflectance of the person's skin;
a property extracting unit which extracts a difference between pixel values of predetermined pixels of subject pictures photographed for each wavelength of the near infrared rays; and
a determining unit which determines whether the pixel corresponds to the skin by comparing the difference between the pixel values extracted by the property extracting unit with the spectrum reflectance information, and decides a region where the pixels corresponding to the skin intensively occupy a predetermined area to a skin region.

3. The human body detecting device according to claim 2, further comprising
a visible light component removing unit which removes influence due to a visible light component of picture data of the subject picture by subtracting picture data of a second subject picture photographed without emitting the light to the subject by the near infrared ray light source from picture data of a first subject picture photographed by emitting the light to the subject by the near infrared ray light source.

4. The human body detecting device according to claim 2, further comprising
an infrared ray transmitting filter which cuts visible light rays.

5. The human body detecting device according to claim 2, further comprising
a coordinate calculating unit for calculating coordinates of the skin region determined by the determining unit.

6. A human body detecting method comprising:
irradiating light emitted from each near infrared ray light source onto a subject;
converging the light which is irradiated onto the subject and is reflected from the subject by the irradiating to form a subject image and forming a subject picture based on the subject image;
storing the subject picture formed by the forming of the photographed picture;
extracting the difference between pixel values of predetermined pixels of subject pictures photographed for each wavelength of near infrared rays; and
comparing the difference between the pixel values extracted by the extracting of the property with the spectrum reflectance information, determining whether the pixel corresponds to the skin, and deciding a region where the pixels corresponding to the skin intensively occupy a predetermined area to a skin region.
